(19) United States
(12) Patent Application Publication
(10) Pub. No.: US 2014/0260164 A1
(43) Pub. Date: Sep. 18, 2014

(54) MULTI-KNIFE STRAIGHT HELICAL STALK ROLL KNIFE

(71) Applicant: AGCO CORPORATION, Duluth, GA (US)

(72) Inventors: Randall Lohrentz, Buhler, KS (US); Marudhu Madheswaran, Hesston, KS (US)

(21) Appl. No.: 13/798,861

(22) Filed: Mar. 13, 2013

(51) Int. Cl. A01D 45/02

(52) U.S. Cl. CPC A01D 45/025
USPC 56/104

(57) ABSTRACT

In one embodiment, a stalk roll comprising a helical flute portion; and a multiple-knife portion adjacent and aft of the helical flute portion, each side of the multiple-knife portion comprising a first group of multiple knives and a second group of multiple knives mounted to a base, the first group separated from the second group by an area of the base comprising hardware and an extension, the hardware coupling the base to the stalk roll, the extension having an open edge that is substantially parallel to a longitudinal axis of the stalk roll and orthogonal to the base, wherein at least one of the multiple knives of the first and second groups is non-orthogonally angled relative to the longitudinal axis of the stalk roll.

### TECHNICAL FIELD

The present disclosure is generally related to headers for agricultural machines and, more particularly, is related to stalk rolls for corn headers.

### BACKGROUND

Agricultural harvesters such as combines are typically equipped with a harvesting header. For instance, corn headers are specifically designed to pick up corn, and vary in size (e.g., two row units, twelve row units, etc.). As the harvester moves through the field, each row unit passes between rows of corn. Corn header row units typically use gathering chains or other mechanisms to covey crop material and ears rearward toward a cross auger. A set of driven stalk rolls, which may rotate based on the speed of the harvester, grabs the corn stalks and forces them downward between stripper plates. The ears of corn are snapped free of the stalk, conveyed by the gathering chains toward the cross auger, and the cross auger passes the ears of corn to the feeder housing of the harvester.

### BRIEF DESCRIPTION OF THE DRAWINGS

Many aspects of the disclosure can be better understood with reference to the following drawings. The components in the drawings are not necessarily to scale, emphasis instead being placed upon clearly illustrating the principles of the present disclosure. Moreover, in the drawings, like reference numerals designate corresponding parts throughout the several views.

FIG. 1 is a schematic diagram showing a front perspective view of an example embodiment of a corn header with plural row units.

FIGS. 2A-2B are schematic diagrams of an example embodiment of a row unit in top and bottom perspective views, respectively.

FIG. 3 is a schematic diagram showing a front perspective view of an example embodiment of a row unit comprising a set of stalk rolls with angled knives.

FIG. 4 is a schematic diagram showing an overhead view of an example embodiment of a row unit comprising a set of stalk rolls with angled knives.

FIG. 5 is a flow diagram that illustrates an example embodiment of a row unit method.

### DESCRIPTION OF EXAMPLE EMBODIMENTS

### Overview

In one embodiment, a stalk roll comprising a helical flute portion; and a multiple knifes portion adjacent and aft of the helical flute portion, the multiple knife portion comprising a first group of multiple knives and a second group of multiple knives mounted to a base, the first group separated from the second group by an area of the base comprising hardware and an extension, the hardware coupling the base to the stalk roll, the extension having an open edge that is substantially parallel to a longitudinal axis of the stalk roll and orthogonal to the base, wherein at least one of the multiple knives of the first and second groups is non-orthogonally angled relative to the longitudinal axis of the stalk roll.

### DETAILED DESCRIPTION

Certain embodiments of a corn header and associated row units and stalk rolls are disclosed that enable efficient and cost-effective harvesting of corn crops. In one embodiment, a corn header is described with plural row units, each row unit comprising plural, segregated groups of multiple, non-orthogonally angled knives (equivalently, sharpened blades, bars, etc.) that perform a similar function to helical knives. In some embodiments, discrete areas located between the groups of knives comprise extensions that serve to mimic the chopping and/or slicing actions of the knives, facilitating the degradation of corn stalks and other residue in the field.

Digressing briefly, conventional stalk rows may use corn header row units with stalk rolls that have straight knives. The stalk rolls, as is known, rotate in opposite direction such that when the corn stalk enters between the rolls, the stalk is grabbed and forced downward. Helical knives reduce or eliminate load spikes that are often caused by straight knives. A twisted helical knife, however, may be difficult to manufacture and may not be easily retrofitted to current designs. As disclosed herein, a knife without a formed twist may achieve the same desirable results as a formed helical knife. Such a “straight helical acting” knife is mounted to the stalk roll on an axis that is not parallel to the stalk roll, and has, in one embodiment, an elliptical formed edge. Knives on one stalk roll run in close proximity to the opposing roll to achieve a scissor-like action that chops and cuts stalks.

Having summarized certain features of a stalk roll for a corn header and associated row unit of the present disclosure, reference will now be made in detail to the description of the disclosure as illustrated in the drawings. While the disclosure is described in connection with these drawings, there is no intent to limit it to the embodiment or embodiments disclosed herein. Further, although the description identifies or describes specifics of one or more embodiments, such specifics are not necessarily part of every embodiment. On the contrary, the intent is to cover all alternatives, modifications and equivalents included within the spirit and scope of the disclosure as defined by the appended claims. Further, it should be appreciated in the context of the present disclosure that the claims are not necessarily limited to the particular embodiments set out in the description.

Referring now to FIG. 1, shown is a schematic diagram showing a front perspective view of an example embodiment of a corn header 10. The corn header 10 may be coupled to the front of an agricultural harvester, such as a combine harvester, as is known to those having ordinary skill in the art. The corn header 10 comprises a cross auger 12 with spiral flighting 14 for sweeping the ears of corn toward the center of the header 10. Large cross augers 12 may also have paddles, fingers, or some other structures to facilitate the delivery of the crop rearward to a feeder housing of the combine harvester. The header 10 has a plurality of forward-extending divider assemblies 16, each divider assembly comprising a snout 18 and gatherer hood 20. The header 10 also comprises a plurality of forward extending row units 22, each row unit comprising a set (e.g., pair) of stalk rolls that operate in opposing rotation. One roll of the pair of stalk rows is associated with (e.g., covered by) one of the divider assemblies 16, whereas the other roll of the pair of stalk rolls is associated with an adjacent divider assembly 16. In other words, a divider assembly 16 may cover two stalk rolls from adjacent row units 22.

The row units 22 and the cross auger 12 define a feeder plane therebetween where useable parts of stalk crops are conveyed rearward from the row units 22 to the cross auger 12. One having ordinary skill in the art should appreciate in the context of the present disclosure that the number of row units 22 may differ among different types of corn headers, and that other configurations of corn headers with or without a different quantity of row units are contemplated to be within the scope of the disclosure.

Referring to FIGS. 2A and 2B, shown in front perspective, top and bottom views, respectively, is an example embodiment of a row unit 22. The row unit 22 comprises a set of counter-rotatable, gathering chains 24A, 24B for conveying harvested crop material, such as ears of corn, rearwardly toward the cross auger 12 (FIG. 1). In some embodiments, other mechanisms for conveying the crop material rearwardly may be used, such as one or more augers. As is known, the gathering chains 24A, 24B each comprise plural lugs, such as lugs 26, to facilitate the rearward conveyance process. As best seen in FIG. 2B, the row unit 22 also comprises a pair of opposably rotatable (e.g., counter-rotating) stalk rolls 28A, 28B disposed beneath the gathering chains 24A, 24B. The stalk rolls 28A, 28B are operable for pulling the crop material (e.g., stalks, leaves, ears of corn, etc.) downwardly and rearwardly, such that ears of corn are stripped by stripper plates 30A, 30B (best shown in FIG. 2A), enabling the ears of corn to be conveyed rearward. Also, the stalk rolls 28A, 28B chop and slice the residue to ultimately be discharged to the ground. Other features of row unit 22, such as the drive system, etc., are well-known to those having ordinary skill in the art and hence omitted here to avoid obfuscating the relevant features.

Exploring the stalk rolls 28A, 28B in further detail, attention is directed now to FIG. 3, which shows, in schematic, a front perspective view of the pair of opposably rotatable stalk rolls 28A, 28B. Focusing on stalk roll 28B, with the understanding that the same or similar description applies to stalk roll 28A, the stalk roll 28B comprises, from fore to aft, a helical flute portion 32 and an adjacent multiple-knife portion 34. The helical flute portion 32 comprises one or more helical flutes 36 that serve as an initial engagement area for stalks of corn, enabling, in cooperation with the helical flute portion of the other stalk roll 28A, the initial pulling down and rearward actions. The multiple-knife portion 34 comprises plural bases 38, such as respective bases 38A, 38B (the other two bases obscured from view in FIG. 3), coupled to the stalk roll 28B. In one embodiment, each base 38 is coupled to the stalk roll 28 using hardware along one or more discrete portions of the length of the base 38 and underlying stalk roll 28. For instance, and referring to the base 38A (with similar applicability to the other bases), the base 38A is coupled to the underlying roll structure of the stalk roll 28B using hardware 40A, 40B, and 40C (e.g., bolts, pins, screws, rivets, welds, etc.) at discrete locations or areas 42A, 42B, and 42C, respectively, fore and aft along the base 38A. In some embodiments, the stalk roll 28 may be configured in another fashion, such as via a two-piece assembly of the helical flute portion 32 affixed to a fore end of an adjacent block portion. It should be appreciated by one having ordinary skill in the art that other configurations or mechanisms for achieving the respective functions of the helical flute portion 32 and multiple-knife portion 34 may be implemented in some embodiments, and hence are contemplated to be within the scope of the disclosure. Also, though shown in FIG. 3 with four (4) sides or bases 38, the multiple-knife portion 34 may have fewer or greater quantities of sides in some embodiments.

Each base 38 further comprises plural segregated groups of multiple knives. For instance, and referring to the base 38A (with similar applicability to the other bases 38) of stalk roll 28B, shown are a plurality of knives 44 that are segregated into at least two groups 46A and 46B of multiple knives 44 each. In some embodiments, each knife 44 may have a beveled (and sharpened) edge or edges. Further, each knife 44 serves to mimic a helical knife without the complication of actually manufacturing a helical knife, enabling a chopping, slicing, and downward conveyance action upon the stalks. In some embodiments, the top edge may be somewhat elliptical in configuration, though not limited to such a geometry. In the embodiment depicted in FIG. 3, there are four (4) knives 44 per group 46A, and four (4) knives 44 for group 46B. In one embodiment, each group 46A and 46B comprises the same quantity of knives 44. In some embodiments, one group may have a different quantity of knives than the other group. Although depicted with two groups 46A and 46B of multiple knives 44, some embodiments may have additional groups of the same or a different quantity. The knives 44 of the base 38A are coupled to the base 38A according to any known mechanism of securement, such as via screws, welds, bolts, etc. In some embodiments, the base 38A and knives 44 may be a molded (e.g., cast) assembly. The base 38A may comprise one or more additional knives (e.g., outside of the groups of multiple knives 44), such as knife 44A located at the aft end of the stalk roll 28B (though some embodiments may have at one or more additional knives the fore end, or both the fore and aft end, where plural such additional knives in a contiguous grouping comprises an additional group).

FIG. 3 also reveals (again, referring to the base 38A, with similar applicability to the other bases) that the groups 46A and 46B are separated from each other by the area 42B. The group 46B is separated from the knife 44A by the other area 42C, and the group 46A is separated from the aft end of the helical flute portion 32 by the area 42A. The areas 42A, 42B, and 42C comprise respective extensions 46A, 46B, and 46C (collectively, extensions 46). The extensions 46 are shown as an extension of the adjacent base 38B, and hence are orthogonal to the base 38A. In some embodiments, the extensions may be an angled (e.g., orthogonally angled) piece of the base 38A. Each of the extensions 46 comprises an open-ended top edge, such as edge 48 of extension 46B, the top edge being parallel (or substantially parallel) to the longitudinal axis of the stalk roll 28B. In some embodiments, the top edge may be somewhat elliptical in geometric configuration, and one or more of the edges may be beveled, similar to the knife edges. In one embodiment, the extensions 46 are sharpened and are of similar dimensional extension into space relative to the stalk roll 28B as the adjacent knives 44. The interspersion of the extensions 46 in the areas 42A, 42B, and 42C circumvents the interference of the knife patterns caused the hardware 40 while enabling the stalk to move in a downward direction to prevent a gap (e.g., in action) corresponding to the areas 42.

With continued reference to FIG. 3, and also referring to FIG. 4, attention is directed to the knives 44. Again referring to the stalk roll 28B (with similar applicability to the stalk roll 28A), an overhead view of the stalk rolls 28B is shown. The stalk roll 28B comprises a longitudinal axis 50, and the knives 44 are angled in a non-orthogonal manner relative to the longitudinal axis 50, as illustrated by angle, α, to enable a helical knife-like action. It should be appreciated that the angle may vary in a manner other than shown in some embodiments. In one embodiment, the knives 44 are mounted at a greater angle, α, than in conventional knives for stalk rolls (the latter being orthogonal to the axis). It should be appreciated that the angle, β, may be used as a matter of reference, with the result that the knives may be considered as mounted at a smaller angle than conventional knife arrangements for stalk rolls. In either case, the non-orthogonal angle enables each knife 44 to transition from a chopping function to a slicing function as the stalk rolls 28 rotate while also maintaining a downward-tugging action on the harvested corn stalk (or other crop material), which may realize greater efficiency and production of more processed corn stalk for improved degradation in the field.

Note that variations of the above are contemplated to be within the scope of the disclosure. For instance, though depicted in FIGS. 3-4 as all having the same angle relative to the longitudinal axis 50, in some embodiments, one or more of the knives 44 of the stalk roll 28B (and corresponding position in stalk roll 28A) may be oriented at a different angle (e.g., larger or smaller than a). In other words, the knife orientation may not be uniform through the entire length of the stalk roll in some embodiments. In some embodiments, different quantities of knives 44 may be used, and in some embodiments, different quantities of groupings (and/or different quantities of knives per group) may be implemented in some embodiments.

Having described some example embodiments of a corn header 10 and associated row units 22 and stalk rolls 28, it should be appreciated in view of the present disclosure that one embodiment of a method 52, depicted in FIG. 5, comprises drawing crop material (e.g., stalk, ears of corn, branches, etc.) downward and rearward using a helical flute portion of each opposably rotated stalk roll of a stalk roll pair (54); and processing residue of the crop material (e.g., stalk) using a plurality of knives of a multiple-knife portion of each stalk roll of the stalk roll pair, at least one of the plurality of knives arranged in a non-orthogonal angle relative to a longitudinal axis of the associated stalk roll (56). The processing may include chopping, slicing, and a downward pulling of the crop material.

It should be emphasized that the above-described embodiments of the present disclosure are merely possible examples of implementations, merely set forth for a clear understanding of the principles of the disclosure. Many variations and modifications may be made to the above-described embodiment(s) of the disclosure without departing substantially from the spirit and principles of the disclosure. All such modifications and variations are intended to be included herein within the scope of this disclosure and protected by the following claims.

At least the following is claimed:

1. A corn header, comprising:
plural row units, each row unit comprising opposably rotatable stalk rolls, each stalk roll comprising a helical flute portion and a multiple-knife portion aft of the helical flute portion, the multiple-knife portion comprising a base having plural, physically segregated groups of multiple knives, each of the multiple knives non-orthogonally angled relative to a longitudinal axis of the stalk roll, wherein a first group is separated by a second group by an area comprising hardware coupling the base of the multiple-knife portion to the stalk roll, wherein the area further comprises an extension substantially orthogonal to the base that mimics the actions of the knives of the first and second groups.

2. The corn header of claim 1, wherein at least one of the plural groups comprises four knives.

3. The corn header of claim 1, wherein the helical flute portion comprises a cylinder having a helical flute disposed thereon.

4. The corn header of claim 1, wherein the multiple-knife portion comprises four bases, each coupled to the stalk roll and all having a similar configuration and quantity of knives.

5. The corn header of claim 1, wherein the base further comprises one or more additional knives, wherein at least one of the one or more additional knives is angled similarly relative to the longitudinal axis as the multiple knives of the plural segregated groups.

6. The corn header of claim 1, wherein the extension comprises an open edge that is substantially parallel to the longitudinal axis.

7. A row unit for a corn header, the row unit comprising:
opposably rotatable stalk rolls, each stalk roll comprising a helical flute portion and a multiple-knife portion aft of the helical flute portion, the multiple-knife portion comprising a base having plural, physically segregated groups of multiple knives, wherein at least one of the multiple knives is non-orthogonally angled relative to a longitudinal axis of the stalk roll.

8. The row unit of claim 7, wherein the physically segregated groups of multiple knives comprise a first group and a second group, the first group separated by the second group by an area comprising hardware that couples the base of the multiple-knife portion to the stalk roll.

9. The row unit of claim 8, wherein the area disposed in between the first and second groups further comprises an extension that is substantially orthogonal to the base.

10. The row unit of claim 9, wherein the extension further comprises an open edge that is substantially parallel to the longitudinal axis.

11. The row unit of claim 8, wherein the quantity of knives in the first group equals the quantity of knives in the second group.

12. The row unit of claim 7, wherein all of the multiple knives are non-orthogonally angled relative to the longitudinal axis of the stalk roll.

13. The row unit of claim 7, wherein at least one of the plural groups comprises four knives.

14. The row unit of claim 7, wherein the helical flute portion comprises a cylinder having a helical flute disposed thereon.

15. The row unit of claim 7, wherein the multiple-knife portion comprises four bases, with each base comprising a similar configuration and quantity of knives.

16. The row unit of claim 7, wherein the base further comprises one or more additional knives.

17. A stalk roll, comprising:
a helical flute portion; and
a multiple-knife portion adjacent and aft of the helical flute portion, the multiple-knife portion comprising a first group of multiple knives and a second group of multiple knives mounted to a base, the first group separated from the second group by an area of the base comprising hardware and an extension, the hardware coupling the base to the stalk roll, the extension having an open edge that is substantially parallel to a longitudinal axis of the stalk roll and orthogonal to the base, wherein at least one of the multiple knives of the first and second groups is non-orthogonally angled relative to the longitudinal axis of the stalk roll.

18. The stalk roll of claim 17, wherein all of the multiple knives of the first and second groups are non-orthogonally angled relative to the longitudinal axis of the stalk roll.

19. The stalk roll of claim 17, wherein the quantity of knives in the first group equals the quantity of knives in the second group.

20. The stalk roll of claim 17, wherein the base further comprises one or more additional knives.
